(19) United States
(12) Patent Application Publication
(10) Pub. No.: US 2007/0275240 A1
(43) Pub. Date: Nov. 29, 2007

(54) Chemically Crosslinkable Adhesive Strips That Can Be Detached By Pulling In The Direction Of The Bond Plane Of Adhesion

(75) Inventor: Thorsten Krawinkel, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 10/581,767

(22) PCT Filed: Nov. 16, 2004
(86) PCT No.: PCT/EP04/52976

§ 371 Date: Apr. 5, 2007

(30) Foreign Application Priority Data
Dec. 23, 2003 (DE) 103 61 540.7

(51) Int. Cl. C09J 151/00

(52) U.S. Cl. 428/356; 524/176

(57) ABSTRACT

An adhesive for an adhesive film strip, comprising a mixture of an acid-modified or acid anhydride-modified vinylaromatic block copolymer, a metal chelate of the following formula:
(R₁O)ₙ M (XR₂Y)ₘ, where M is a metal from main group 2, 3, 4 or 5 or a transition metal;
R₁ is an alkyl or aryl group; n is zero or a greater whole number;
X and Y are oxygen or nitrogen, and may each also be attached through a double bond to R₂;
R₂ is an alkylene group connecting X and Y and may be branched, or else may contain oxygen or other heteroatoms in the chain; m is a whole number, but at least 1; and a tackifier resin, the adhesive film strip being detachable by extensive stretching in the direction of the bondline.

The invention relates to an adhesive for single- or double-sided adhesive film strips which are redetachable without residue or destruction by extensive stretching in the plane of adhesion and which possess good adhesive properties even at an elevated temperature. The invention relates further to an adhesive film strip produced from such an adhesive.

Elastically or plastically highly extensible self-adhesive tapes which are redetachable without residue or destruction by extensive stretching in the plane of adhesion are known for example from U.S. Pat. No. 4,024,312 A, DE 33 31 016 C2, WO 92/11332 A1, WO 92/11333 A1, DE 42 22 849 A1, WO 95/06691 A1, DE 195 31 696 A1, DE 196 26 870 A1, DE 196 49 727 A1, DE 196 49 728 A1, DE 196 49 729 A1, DE 197 08 364.A1, DE 197 20 145 A1, DE 198 20 858 A1, WO 99/37729 A1 and DE 100 03 318 A1 and are sometimes referred to below as strippable self-adhesive tapes.

Strippable self-adhesive tapes of this kind are frequently used in the form of single- or double-sidedly pressure-sensitive adhesive film strips, which preferably have a nonadhesive grip region from which the detachment operation is initiated. Particular applications of such self-adhesive tapes are found in patents including DE 42 33 872 A1, DE 195 11 288 A1, U.S. Pat. No. 5,507,464 A, U.S. Pat. No. 5,672,402 A and WO 94/21157 A1. Specific embodiments are also described in DE 44 28 587 A1, DE 44 31 914 A1, WO 97/07172 A1, DE 196 27 400 A1, WO 98/03601 A1 and DE 196 49 636 A1, DE 197 20 526 A1, DE 197 23 177 A1, DE 197 23 198 A1, DE 197 26 375 A1, DE 197 56 084 A1, DE 197 56 816 A1, DE 198 42 864 A1, DE 198 42 865 A1, WO 99/31193 A1, WO 99/37729 A1, WO 99/63018 A1, WO 00/12644 A1, and DE 199 38 693 A1.

Preferred fields of use of aforementioned strippable adhesive film strips include in particular the residuelessly and nondestructively redetachable fixing of light to moderately heavy articles in the home, workplace, and office segments. In these applications they replace conventional fastening means, such as drawing pins, roundhead needles, thumb tacks, nails, screws, conventional self-adhesive tapes, and liquid adhesives, for example. Key to the successful use of the abovementioned adhesive film strips is not only the possibility of residueless and nondestructive redetachment of bonded articles but also their quick and easy bonding and their secure hold for the envisaged period of bonding. It should be borne in mind in particular here that the adhesive strips must possess functionality on a multiplicity of substrates in order to be able to serve as a universal fixing in the home, workplace, and office segments.

Despite the fact that the patent literature cited above describes a broad range of pressure-sensitive adhesives (PSAs) for use in strippable self-adhesive tapes, commercial products currently on the market (for example, tesa™ Powerstrips™ from tesa AG, 3M Command™ adhesive strips from 3M, Plastofix™ Formuli Force 1000 adhesive strips from Plasto S. A., and the corresponding adhesive strips from Nitoms) all have PSAs based on styrene block copolymers, usually with unsaturated polydiene blocks in the elastomer block. Use is made typically of linear or radial block copolymers based on polystyrene blocks and polybutadiene blocks and/or polyisoprene blocks: i.e., for example, radial styrene-butadiene (SB)ₙ and/or linear styrene-butadiene-styrene (SBS) and/or linear styrene-isoprene-styrene (SIS) block copolymers. Advantages of the aforementioned styrene block copolymer-based PSAs for use in strippable self-adhesive tapes are, for example, the high bond strengths which can be achieved with them (owing, among other things, to the simultaneous realization of high cohesion and high adhesive forces), a pronounced reduction in tack during stretching detachment (which greatly facilitates, if not indeed being a precondition for, the operation of detachment), and a high tensile strength, which is essential in particular for an operation of attachment with no tearing.

The products available on the market, all of which utilize PSAs based on styrene block copolymers, exhibit weaknesses in not only the bonding of heavy articles but also the bond strength at temperatures above 50° C. Softening of the hard phases composed primarily of polystyrene (block polystyrene domains), particularly when moderately heavy articles are being bonded, results in cohesive failure on the part of the PSA strips.

Bond failure occurs to a much greater extent particularly when there is a tipping shearing load (when a torque is active, such as when bonding a hook, for example) than in the case of a simple shearing load.

Crosslinkable strippable adhesives are known from DE 198 33 174 C2 and DE 102 12 049 A1. Crosslinking in DE 102 12 049 A1 is accomplished via radiation, either UV radiation or electron beams. Crosslinking via chelates is not mentioned. DE 198 33 174 C2 describes chemical crosslinking, but only resins are crosslinked—there is no crosslinking of the elastomers.

Crosslinking of maleic anhydride-modified block copolymers with chelates is known from EP 1 311 559 A2, accompanied by a description of an increase in the cohesion of the block copolymer mixtures. Any possibility of producing adhesive tapes which are crosslinked by the mechanism described and at the same time can be detached from the bondline by extensive stretching in the direction of the plane of adhesion is not mentioned.

Also known are chelate crosslinkings with, for example, acid-modified acrylate adhesives, from U.S. Pat. No. 4,005,247 A or U.S. Pat. No. 3,769,254 A, for example.

It is an object of the invention, therefore, to create an improved adhesive based on vinylaromatic block copolymers for adhesive film strips which are redetachable without residue or destruction by extensive stretching in the direction of the bond plane and which exhibit good bond strength at elevated temperature and are suitable even for the fastening of heavy objects.

This object is achieved in accordance with the invention by a generic adhesive as specified in the main claim. The dependent claims provide advantageous developments of the adhesive, and also provide for its use in an adhesive strip.

The invention accordingly provides an adhesive for an adhesive film strip, comprising a mixture of

an acid-modified or acid anhydride-modified vinylaromatic block copolymer,

a metal chelate of the following formula:
(R₁O)ₙ M (XR₂Y)ₘ,
where
M is a metal from main group 2, 3, 4 or 5 or a transition metal;
R₁ is an alkyl or aryl group;
n is zero or a greater whole number;
X and Y are oxygen or nitrogen, and may each also be attached through a double bond to R₂;
R₂ is an alkylene group connecting X and Y and may be branched, or else may contain oxygen or other heteroatoms in the chain;
m is a whole number, but at least 1;
and a tackifier resin,
   the adhesive film strip being detachable by extensive stretching in the direction of the bondline.

As a result of the crosslinking, which occurs as a result of the positioning of the chelate groups at the acid or anhydride groups, there is a distinct improvement in the cohesive properties, particularly at elevated temperatures. Surprisingly it has emerged that in spite of this chemical crosslinking the strippability is retained. In spite of the high bonding performance it is possible to detach the PSA tapes from the bondline again by pulling in the direction of the plane of adhesion.

In order for strippable adhesive tapes to be able to be redetached easily and without residue they must possess certain mechanical properties. The ratio of the tearing force to the stripping force must be greater than two, preferably greater than three. The stripping force is the force which it is necessary to expend in order to redetach an adhesive strip from a bondline by parallel pulling in the direction of the plane of adhesion. The ratio of stripping force to tearing force is influenced strongly by the thickness of the adhesive strips, since the removal force required for detachment is composed of the force needed to detach the adhesive tape from the bond substrates and the force one has to expend to deform the adhesive tape. The force required for deforming the adhesive tape is approximately proportional to the thickness of the adhesive tape. The removal force required for detachment can be assumed for simplicity to be constant within the thickness range under consideration. The tear strength, in contrast, rises in proportion to the thickness of the adhesive strips. It follows from this that, for adhesive tapes having a single-layer construction, as disclosed in DE 33 31 016 C2, the tear strength, below a certain thickness, becomes smaller than the removal force. Above a certain thickness, on the other hand, the ratio of removal force to stripping force becomes greater than two. If the tearing force of the polymers used, however, is very low, it follows that the thickness must become very great, so also increasing the stripping forces. In order to prevent the force required for stripping from becoming too great, however, the stripping force per adhesive strip ought not to be greater than 30 N.

Rather than in a single-layer construction, in which the entire adhesive strip is composed of adhesive, adhesives of the invention can also be employed in multilayer constructions with a carrier in between. Possible carriers here include not only predominantly elastic carriers, as described for example in U.S. 4,024,312 A or DE 197 08 366 A1, but also predominantly plastic carriers, as described in WO 92/11333 A1 or, for example, DE 196 49 727 A1.

Also possible are single-sidedly adhesive tapes which possess a layer of adhesive on only one side of a carrier (or backing). Also conceivable are adhesive tapes which, although provided with adhesive on two sides, carry a different adhesive on either side of the carrier. These adhesive tapes can be used to particularly good effect for bonding two very different materials, the two adhesives then being able to be tailored exactly to the respective substrate.

Adhesives employed are preferably those based on block copolymers containing polymer blocks formed predominantly of vinylaromatics (A blocks), preferably styrene, and blocks predominantly formed by polymerization of 1,3-dienes (B blocks), preferably butadiene and isoprene. Both homopolymer and copolymer blocks can be utilized in accordance with the invention. Resulting block copolymers may contain identical or different B blocks, which may have been partly or selectively hydrogenated. Block copolymers may have a linear A-B-A structure. It is likewise possible to employ block copolymers of radial design, and also star-shaped and linear multiblock copolymers. Further components that may be present include A-B diblock copolymers. All of the aforementioned polymers can be utilized either alone or in a mixture with one another.

At least some of the block copolymers used must be acid-modified or acid anhydride-modified, the modification taking place primarily by means of free-radical graft copolymerization of unsaturated monocarboxylic and polycarboxylic acids or anhydrides, such as, for example, fumaric acid, itaconic acid, citraconic acid, acrylic acid, maleic anhydride, itaconic anhydride or citraconic anhydride, preferably maleic anhydride. The fraction of acid or acid anhydride is preferably between 0.5% and 4% by weight, based on the block copolymer as a whole.

Block copolymers of this kind are available commercially under, for example, the name Kraton™ FG 1901 and Kraton™ FG 1924 from Shell, and as Tuftec™ M 1913 and Tuftec™ M 1943 from Asahi.

The styrene block copolymer fraction of the pressure-sensitive adhesive is preferably 20% to 70%, more preferably 30% to 60%, and very preferably 35% to 55% by weight; it is not necessary for the entire fraction of block copolymers to be in anhydride-modified form.

Besides the acid-modified or acid anhydride-modified vinylaromatic block copolymers already mentioned it is also possible to add further acids or acid anhydrides in order to achieve a higher degree of crosslinking and hence an even further improved cohesion. In this case it is possible to employ not only monomeric acid anhydrides and acids as described in U.S. Pat. No. 3,970,608 A but also acid-modified or acid anhydride-modified polymers and acid anhydride copolymers such as polyvinyl methyl ether-maleic anhydride copolymers, obtainable for example under the name Gantrez™, sold by ISP.

As tackifiers, adhesives of the invention utilize as a main component, in particular, tackifier resins which are compatible with the elastomer block of the vinylaromatic block copolymers.

Those suitable with preference include unhydrogenated, partly hydrogenated or fully hydrogenated resins based on rosin and rosin derivatives, hydrogenated polymers of dicyclopentadiene, unhydrogenated, partly, selectively or fully hydrogenated hydrocarbon resins based on C₅, C₅/C₉ or C₉ monomer streams, polyterpene resins based on α-pinene and/or β-pinene and/or δ-limonene, and hydrogenated polymers of preferably pure C₈ and C₉ aromatics. Aforementioned tackifier resins may be used either alone or in a mixture.

Further additives which can typically be utilized include the following:

primary antioxidants, such as sterically hindered phenols

secondary antioxidants, such as phosphites or thioethers

in-process stabilizers, such as C radical scavengers

light stabilizers, such as UV absorbers or sterically hindered amines

processing aids

endblock reinforcer resins

fillers, such as silica, glass (ground or in the form of beads), aluminas, zinc oxides, calcium carbonates, titanium dioxides, carbon blacks, etc., and also color pigments and dyes, and optical brighteners

if desired, further polymers, preferably elastomeric in nature; elastomers which can be utilized accordingly include, among others, those based on single hydrocarbons, unsaturated polydienes for example, such as natural or synthetic polyisoprene or polybutadiene, chemically substantially saturated elastomers, such as saturated ethylene-propylene copolymers, α-olefin copolymers, polyisobutylene, butyl rubber, ethylene-propylene rubber, and chemically functionalized hydrocarbons, such as halogen-containing, acrylate-containing or vinyl ether-containing polyolefins, to name but a few.

Plasticizing agents, such as liquid resins, plasticizer oils or low molecular mass liquid polymers, such as, for example, low molecular mass polybutenes with molar masses<1500 g/mol (number average), are employed only in very small amounts of≦10% by weight, and preferably are not used at all.

The tack of the PSA may optionally be generated only by thermal activation or by solvent activation.

The metals of the metal chelates may be those from main groups 2, 3, 4 and 5 and the transition metals. Particularly suitable examples include aluminum, tin, titanium, zirconium, hafnium, vanadium, niobium, chromium, manganese, iron, cobalt, and cerium. Aluminum and titanium are particularly preferred.

The metal chelates are illustrated by the following formula:
(R₁O)ₙ M (XR₂Y)ₘ,
where
M is a metal as described above;
R₁ is an alkyl or aryl group such as methyl, ethyl, butyl, isopropyl or benzyl;
n is zero or a greater whole number;
X and Y are oxygen or nitrogen, and may each also be attached through a double bond to R₂;
R₂ is an alkylene group connecting X and Y and may be branched, or else may contain oxygen or other heteroatoms in the chain;
m is a whole number, but at least 1.

Preferred chelate ligands are those which have come about from the reaction of the following compounds: triethanolamine, 2,4-pentanedione, 2-ethyl-1,3-hexanediol or lactic acid.

Particularly preferred crosslinkers are aluminum and titanium acetylacetonates.

The aim here should be to choose an approximately equivalent ratio between the acid or acid anhydride groups and the acetylacetonate groups, in order to achieve optimum crosslinking; a small excess of crosslinker has been found positive.

The ratio between anhydride groups and acetylacetonate groups, however, can be varied; the aim here, for sufficient crosslinking, should be for neither of the groups to be present in a molar excess of more than five fold.

The preparation and processing of the PSAs may take place either from solution or from the melt. Particular preference, however, is given to manufacturing the PSAs from the melt, in which case batch methods, in particular, and also continuous methods, can be employed. It is particularly advantageous to manufacture the PSAs continuously by means of an extruder, the acetylacetonate being added as far as possible at the end of the operation.

Adhesives of the invention can be utilized not only for single-sided but also for double-sided adhesive tapes redetachable without residue or destruction by extensive stretching.

Single-sided adhesive tapes can be obtained, for example, by neutralizing the tack of double-sided adhesive tapes referred to above, or by coating just one side of a highly extensible carrier (backing).

The adhesive films produced can be converted in the form of adhesive tape rolls, adhesive strips or diecuts. An option is to provide a nonadhesive grip tab region, starting from which the operation of detachment can be performed.

Recited below are a number of examples of crosslinked strippable adhesives.

In these examples the PSAs were processed to a homogeneous mixture in a heatable compounder with sigma blade (Werner und Pfleiderer LUK 1,0 K3, equipped with an LTH 303 thermostat from mgw LAUDA) at a temperature of approximately +160 to +180° C. and with gas inertizing using CO₂. The crosslinker was added as the final component just a short way before the end of the kneading operation. After the mixture had cooled, single-layer adhesive film sections of thickness 700 μm±50 μm (average value±2-times standard deviation) were produced by compression of the adhesive at +120° C. to +140° C. in a temperature-controllable press (type KHL 50 from Bucher-Guyer) for approximately 10 minutes.

Diecutting gives single-layer PSA strips of the desired dimensions. To produce multilayer PSA strips the corresponding layers can be joined beforehand by lamination (hot lamination where appropriate), after which the adhesive strips can be individualized by diecutting.

The invention is explained in more detail below with reference to examples, without wishing thereby to restrict the invention in any way whatsoever.

### INVENTIVE EXAMPLE 1

| | | |
|---|---|---|
| 20 | parts | Kraton ™ FG 1901 maleic anhydride-modified SEBS |
| | | from Kraton |
| 80 | parts | Kraton ™ FG 1924X maleic anhydride-modified SEBS |
| | | from Kraton |
| 100 | parts | Escorez ™ 5600 hydrogenated hydrocarbon resin |
| | | from Dexco |
| 4 | parts | aluminum acetylacetonate |

### COMPARATIVE EXAMPLE 2

The same as in Example 1 but without aluminum acetylacetonate.

For the PSA strips with the PSA mixtures exemplified, the following mechanical and technical adhesive data were found:

| | Tensile | Stripping | | Failure |
|---|---|---|---|---|
| PSA of | strength | stress | Peel rate | temperature |
| Example | in MPa | in MPa | in mm/24 h | in ° C. |
| 1 | 7.8 | 1.1 | 19 | >180 |
| 2 | 7.5 | 0.9 | 15 | 88 |

In spite of the crosslinking during preparation, adhesive 1 was still strippable. The mechanical properties at room temperature alter only slightly as a result of the crosslinking.

However, the cohesive properties alter considerably at elevated temperatures. Whereas the comparative example fails cohesively at just 88° C., there is no failure up to 180° C. for inventive example 1. The heat stability has therefore been significantly increased.

The mechanical and technical adhesive data were determined as follows:

The tensile strength and maximum extension were measured in a method based on DIN 53504 using dumbbells of size S3 at a separation rate of 300 mm per minute.

The detachment force (stripping force or stripping stress) was determined using an adhesive film measuring 50 mm long×20 mm wide with a nonadhesive grip tab region at the top end. The adhesive film was bonded between two steel plates, arranged congruently with one another and measuring 50 mm×30 mm, using an applied pressure of 50 newtons in each case. For the purpose of crosslinking, the steel plates were pressed at 200° C. for 5 minutes. At their bottom end the steel plates each have a bore to accommodate an S-shaped steel hook. The lower end of the steel hook carries a further steel plate which allows the test arrangement to be fixed in the lower clamping jaw of a tensile testing machine for the purpose of measurement. The adhesive bonds are stored at +40° C. for a duration of 24 hours. After reconditioning to room temperature, the adhesive film strip is extracted with a pulling speed of 1000 mm per minute parallel to the plane of adhesive and without contact with the edge regions of the two steel plates. During this procedure the required detachment force is measured, in newtons (N). The figure reported is the average value of the stripping stresses (in N per mm²), measured in the range in which the adhesive strip has undergone detachment from the steel substrates over a bonding length of between 10 mm and 40 mm.

For the determination of the peel strength, the PSA strip specimens for investigation are laminated over the entire area of one side with a 23 μm PET film (Hostaphan RN 25; Mitsubishi Chemicals, for example) without air bubbles. After this has been done the second adhesive film strip side is covered at one end with a film strip (again Hostaphan RN 25) approximately 6 mm long, so forming at this end a nonadhesive grip tab region on both sides. Thereafter the adhesive film strip under test is bonded by its front side, using gentle finger pressure, to the test substrate (coated woodchip wallpaper: wallpaper=Erfurt Körning 52, color=Herbol Zenit LG, wallpaper bonded to compressed chipboard). The PSA film specimens are subsequently pressed for 10 seconds at an applied pressure of 90 N per 10 cm² of bonding area and are then conditioned at 40° C. for 15 minutes. The test plates are then fixed horizontally so that the grippable region of the adhesive strips is pointing downward. Using a clamp, a 20 g weight is fastened to the nonadhesive grip tab, so that the resulting peeling load (approximately 0.2 N per 20 mm of adhesive strip width) acts orthogonally to the plane of adhesion. After a test phase of 15 minutes, and a repeat after 24 hours, a mark is made of the distance over which the adhesive strip has peeled away from the bond substrate since the beginning of the test. The distance between the two marks is reported as the peel path (unit: mm per 24 hours).

To determine the thermal shearing path, the adhesive film under test, measuring 10 mm×50 mm, is adhered to a smaller steel plate, so that the bonding area is 10 mm×13 mm. A PET film 23 μm thick is laminated to the reverse of the adhesive film. After the adhesive film has been rolled on using a 2 kg roller, the steel plate is suspended vertically and a 200 g weight is hung from the adhesive film. The steel plate is subsequently heated at a rate of 2° C. per minute. The shearing of the adhesive film is measured, in mm. The adhesive film is held to have fallen off when the shearing path is greater than 2500 μm. The temperature under this shearing is the failure temperature.

1. An adhesive for an adhesive film strip, comprising a mixture of
an acid-modified or acid anhydride-modified vinylaromatic block copolymer,
a metal chelate of the following formula:
(R₁O)ₙ M (XR₂Y)ₘ,
where
M is a metal from main group 2, 3, 4 or 5 of the periodic table of elements, or a transition metal;
R₁ is an alkyl or aryl group;
n is zero or a greater whole number;
X and Y are oxygen or nitrogen, optionally attached through a double bond to R₂;
R₂ is an alkylene group connecting X and Y and may be branched, or else may contain oxygen or other heteroatoms in the chain;
m is a whole number, but at least 1;
and a tackifier resin,
the adhesive film strip being detachable by extensive stretching in the direction of the bondline.

2. The adhesive of claim 1, wherein the vinylaromatic block copolymers possess polystyrene endblocks.

3. The adhesive of claim 1 wherein the adhesive comprises further elastomers, further acids, further acid anhydrides or combinations thereof.

4. The adhesive of claim 1, having a fraction of 20% to 70% by weight of vinylaromatic block copolymer, based on the weight of adhesive as a whole.

5. The adhesive of claim 1, comprising further blend components, selected from the group consisting of plasticizers, aging inhibitors, processing aids, fillers, dyes, optical brighteners, and stabilizers.

6. The adhesive of claim 1, wherein the metal chelates are acetylacetonates.

7. A single- or double-sided adhesive film strip comprising the adhesive of claim 1.

8. An adhesive film strip of claim 7, wherein said adhesive on at least one side of said adhesive film strip has a multilayer construction with an extensible carrier in between the layers.

9. The adhesive of claim 4, wherein said amount of vinylaromatic block copolymers is 30% to 60% by weight.

10. The adhesive of claim 9, wherein said amount of vinylaromatic block copolymers is 35% to 55% by weight.
